(19) United States
(12) Patent Application Publication
(10) Pub. No.: US 2014/0247257 A1
(43) Pub. Date: Sep. 4, 2014

(54) METHOD OF DATA DEPENDENT PRE-CHARGING FOR A SOURCE DRIVER OF AN LCD

(71) Applicant: HIMAX TECHNOLOGIES LIMITED, Tainan City (TW)

(72) Inventors: Chun-Yi Li, Tainan City (TW); Huan-Sen Liao, Tainan City (TW); Way-Guo Tseng, Tainan City (TW); Jen Chun Peng, Tainan City (TW)

(73) Assignee: HIMAX TECHNOLOGIES LIMITED, Tainan City (TW)

(21) Appl. No.: 13/784,610

(22) Filed: Mar. 4, 2013

(51) Int. Cl. G09G 3/36

(52) U.S. Cl. CPC G09G 3/3696
USPC 345/209

(57) ABSTRACT

A method of data dependent pre-charging for a source driver of a liquid crystal display (LCD) is disclosed. Pre-charging is dynamically performed among plural pre-charging schemes according to pixel data corresponding to required output voltage levels to be outputted from channels of the source driver.

### BACKGROUND OF THE INVENTION

1. Field of the Invention

The present invention generally relates to pre-charging, and more particularly to a method of data dependent pre-charging for a source driver of an LCD.

2. Description of Related Art

As a resolution of a liquid crystal display (LCD) becomes higher and a panel size of the LCD larger, drivers adopted in the LCD consume more power. A scheme that pre-charges an output voltage before it is finally generated is therefore proposed to conserve power.

The pre-charging scheme conventionally adopted in the LCD panel is unvarying in nature. That is, the same pre-charging scheme is performed throughout the process no matter how the pixel data change or what pixel data pattern is. As a result, with respect to some pixel data patterns, performing pre-charging incurs more power consumption, instead of saving power.

A need has thus arisen to propose a novel method of dynamically pre-charging a source driver of an LCD.

### SUMMARY OF THE INVENTION

In view of the foregoing, it is an object of the embodiment of the present invention to provide a method of data dependent pre-charging for a source driver of an LCD for dynamically performing pre-charging among plural pre-charging schemes according to pixel data, therefore greatly reducing power consumption.

According to one embodiment, provided powers include a positive supply voltage (VCC) that is supplied from a power supply, a ground (VSS), a generated negative supply voltage (VCCN) that is generated by inverting VCC, a positive amplified supply voltage (VDDAP) that is generated based on VCC with a first amplification factor k1 and a negative amplified supply voltage (VDDAN) that is generated based on an inverted VCC with a second amplification factor k2, wherein a voltage located between VSS and VDDAP has a positive polarity (P), and a voltage located between VSS and VDDAN has a negative polarity (N). Pre-charging is dynamically performed among plural pre-charging schemes according to pixel data corresponding to required output voltage levels to be outputted from channels of the source driver, in case of polarity switching between a current line and a preceding line.

### BRIEF DESCRIPTION OF THE DRAWINGS

FIG. 1A shows some supply powers adopted in embodiments of the present invention;

FIG. 1B shows an exemplary circuit configured to generate an output voltage at an out put node of a source driver;

FIG. 2 shows an exemplary output voltage waveform;

FIG. 3 shows an exemplary output voltage waveform with polarity switching N→P adopting a 2-step pre-charging scheme;

FIG. 4 shows an exemplary output voltage waveform with polarity switching N→P adopting a 3-step pre-charging scheme;

FIG. 5A and FIG. 5B show exemplary output voltage waveforms adopting the 3-step pre-charging scheme and 2-step pre-charging scheme, respectively;

FIG. 6 shows relationship between voltage levels and one MSB of pixel data;

FIG. 7 shows relationship between voltage levels and two MSBs of pixel data;

FIG. 8 shows an exemplary output voltage waveform with polarity switching N→P adopting a 4-step pre-charging scheme; and

FIG. 9A through FIG. 9D show four cases of no polarity switching.

### DETAILED DESCRIPTION OF THE INVENTION

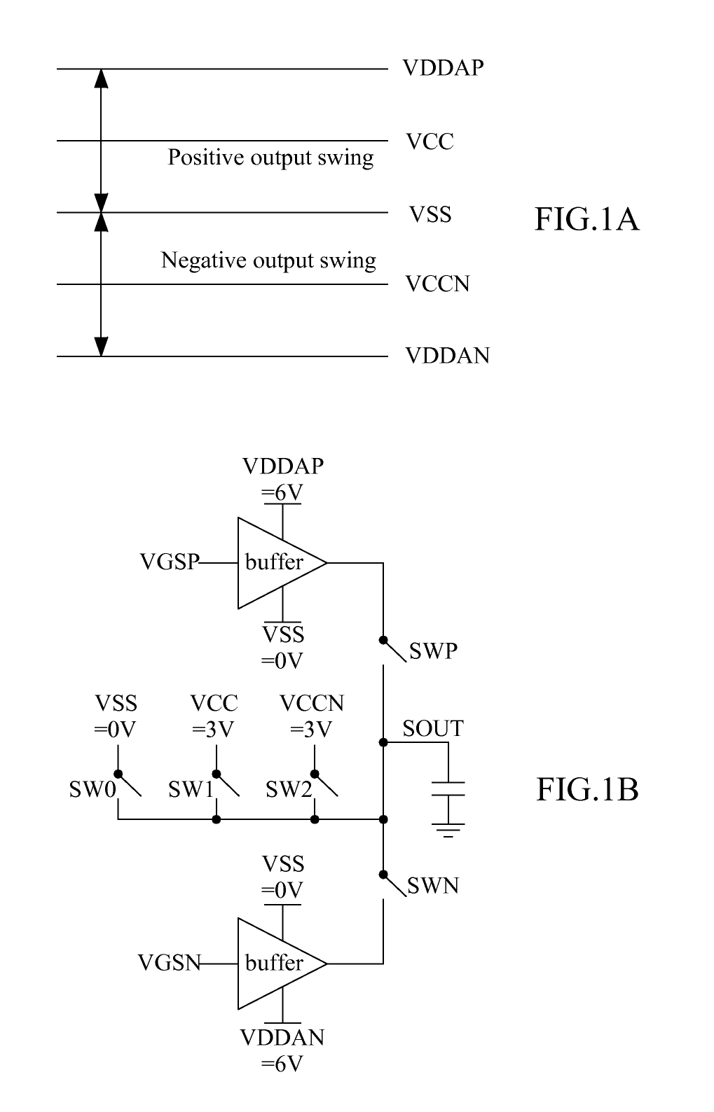

FIG. 1A shows some supply powers adopted in embodiments of the present invention. The powers may include a positive supply voltage VCC (e.g., 3V) that is externally) supplied from a power supply; a ground VSS (e.g., 0V); a generated negative supply voltage VCCN (e.g., −3V) that is (internally) generated, for example, by inverting VCC; a positive amplified supply voltage VDDAP (e.g., 6V) that is (internally) generated based on VCC with a first amplification factor k1 (e.g., 2); and a negative amplified supply voltage VDDAN (e.g., −6V) that is (internally) generated based on inverted VCC with a second amplification factor k2 (e.g., 2). A range from VSS to VDDAP defines a positive output swing (or positive output range), and a range from VSS to VDDAN defines a negative output swing (or negative output range). FIG. 1B shows an exemplary circuit configured to generate an appropriate output voltage at an output node SOUT of a source driver with VDDAP, VCC, VSS, VCCN and VDDAN by closing switches SWP, SW1, SW0, SW9 and SWN, respectively.

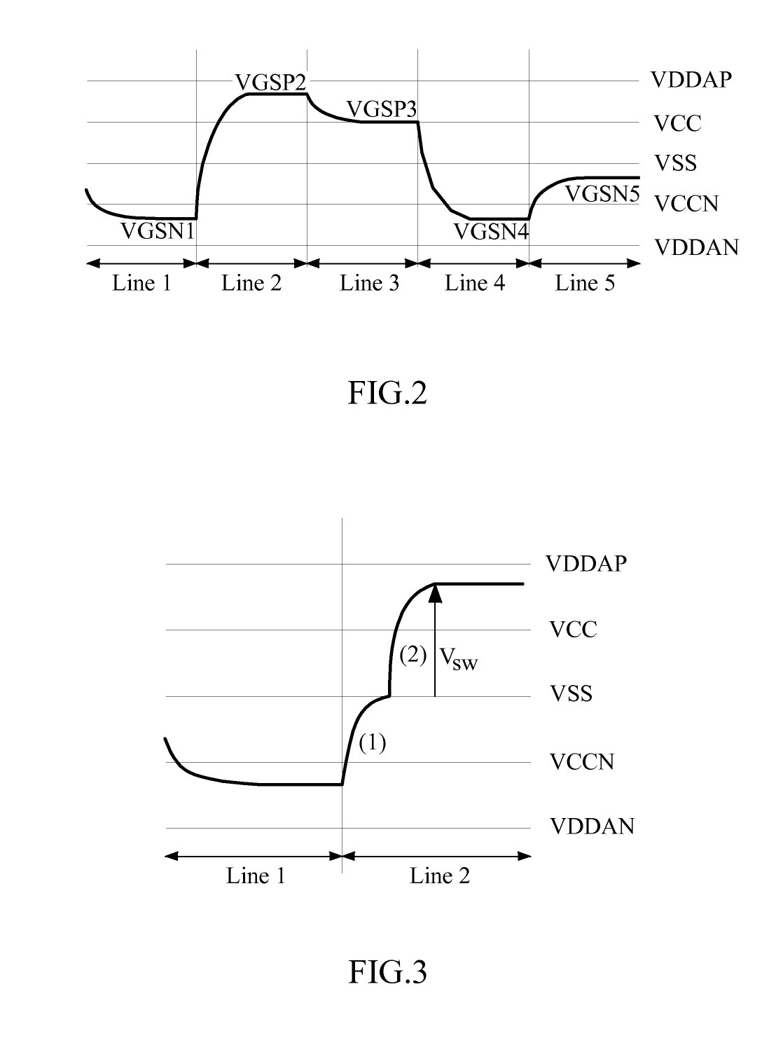

In the specification, a voltage located within the positive output range has a positive polarity (P), and a voltage located within the negative output range has a negative polarity (N). FIG. 2 shows an exemplary output voltage waveform, from an output channel of a source driver of a liquid crystal display (LCD), illustrating polarity switching among successive lines (e.g., lines 1-5) of pixel data. For example, polarity switches from N to P between line 1 and line 2; no polarity switching (i.e., P→P) occurs between line 2 and line 3; polarity switches from P to N between line 3 and line 4; and no polarity switching (i.e., N→N) occurs between line 4 and line 5.

Take the polarity switching N→P for example, as exemplified in FIG. 3, the source driver may adapt a 2-step pre-charging scheme that (1) pre-charges an output voltage to VSS, and then (2) pulls the output voltage from VSS to a required output voltage level with a voltage swing designated as V_{SW}. Similarly, with respect to the polarity switching P→N, the 2-step pre-charging scheme (1) pre-charges an output voltage to VSS, and then (2) pulls the output voltage from VSS to a required output voltage level.

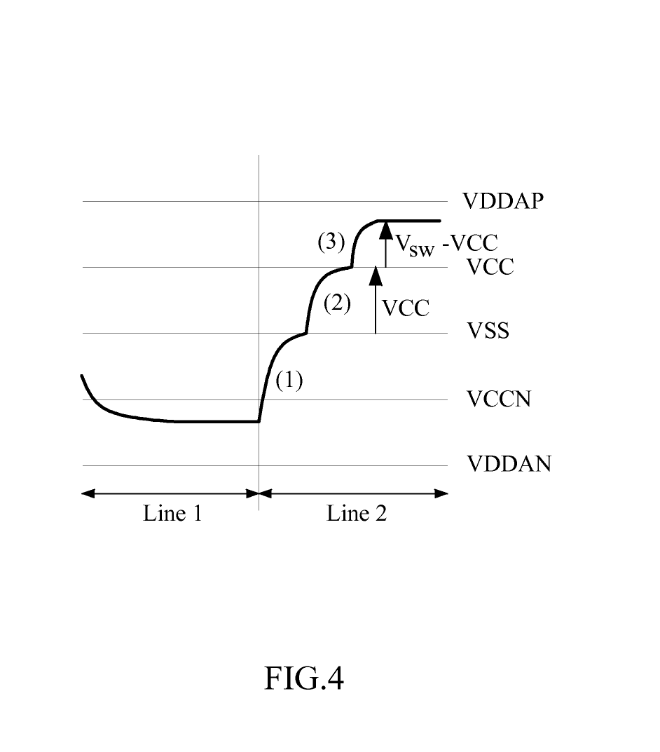

FIG. 4 shows another scheme, for example, a 3-step pre-charging scheme for performing the polarity switching N→P. The 3-step pre-charging scheme (1) pre-charges an output voltage to VSS, (2) subsequently pre-charges the output voltage from VSS to VCC with a voltage swing equal to VCC, and then (3) pulls the output voltage from VCC to a required output voltage level with a voltage swing designated as V_{SW}−VCC. Compared with the 2-step pre-charging scheme of FIG. 3, the 3-step pre-charging scheme of FIG. 4 consumes less power because the step (2) consumes less current from VCC, instead of consuming more current from VDDAP as in FIG. 3. Similarly, with respect to the polarity switching P→N, the 3-step pre-charging scheme (1) pre-charges an output voltage to VSS, (2) subsequently pre-charges the output voltage from VSS to VCCN with a voltage swing equal to an absolute value of VCCN, and then (3) pulls the output voltage from VCCN to a required output voltage level.

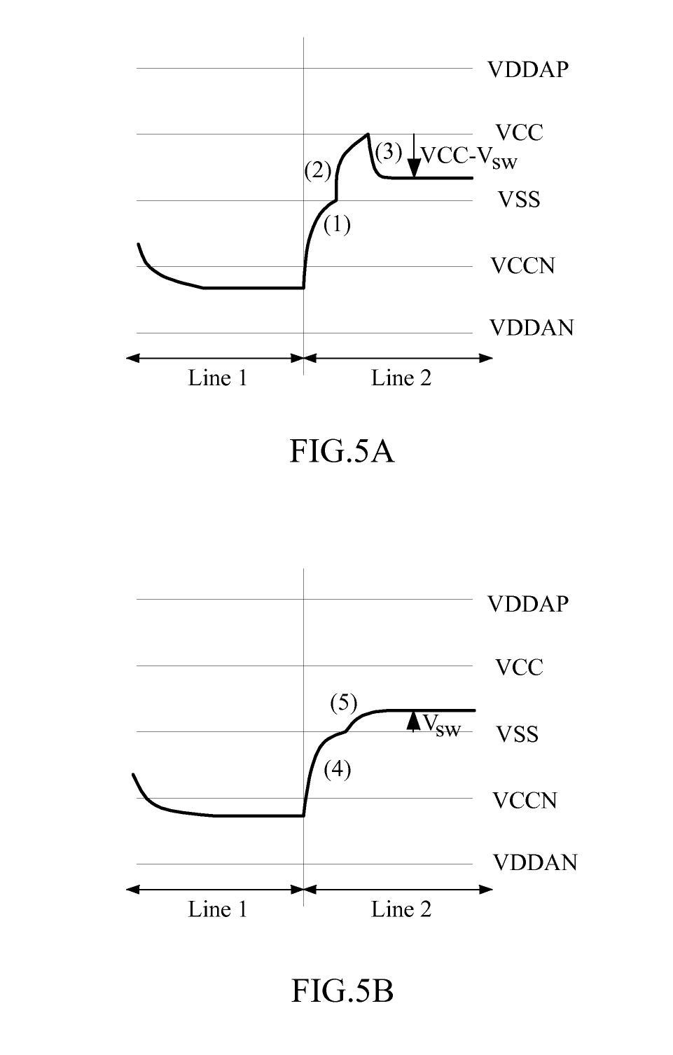

It is noted that the 3-step pre-charging scheme of FIG. 4 is not always consuming less power than the 2-step pre-charging scheme of FIG. 3. As exemplified in FIGS. 5A and 5B for a required output voltage level located between VSS and VCC, particularly, nearer VSS than VCC, a 3-step pre-charging scheme is adapted as shown in FIG. 5A, and a 2-step pre-charging scheme is adapted as shown in FIG. 5B. It is observed that the 3-step pre-charging scheme (FIG. 5A) consumes more power than the 2-step pre-charging scheme (FIG. 5B).

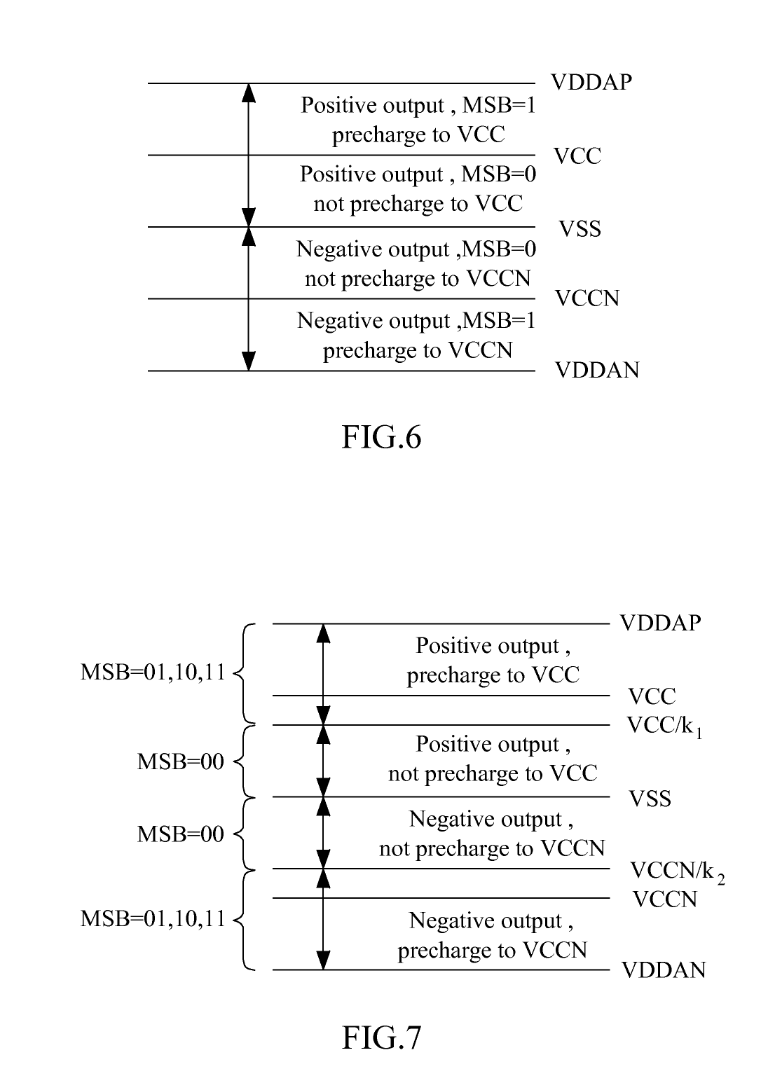

For the foregoing demonstrations, a method of data dependent pre-charging for a source driver of an LCD is proposed according to one embodiment of the present invention. In the embodiment, as shown in FIG. 6, if a most-significant-bit (MSB) of a pixel datum corresponding to a required output voltage level to be outputted from a channel is “0”, indicating that the output voltage level is approximately within VSS and VCC for a polarity switching N→P, the 2-step pre-charging scheme discussed above is adopted without pre-charging to VCC; otherwise, if the MSB is “1”, indicating that the output voltage level is approximately within VCC and VDDAP, the 3-step pre-charging scheme discussed above is adopted with pre-charging to VCC. Similarly, regarding the polarity switching P→N, if the MSB is “0”, the 2-step pre-charging scheme discussed above is adopted without pre-charging to VCCN; otherwise, if the MSB is “1”, the 3-step pre-charging scheme discussed above is adopted with pre-charging to VCCN. Accordingly, pre-charging may be effectively performed based on the pixel datum corresponding to the required output voltage level to be outputted from the channel of the source driver. It is noted that, in practice, as VCC is not exactly separating pixel data with MSB=“0” and pixel data with MSB=“1”, the embodiment discussed above may not be performed fully optimally but with some (tolerably) unfavorable area.

According to another embodiment of the present invention, as shown in FIG. 7, two most-significant-bits (MSBs), instead of one MSB, of a pixel datum corresponding to a required output voltage level to be outputted from a channel are used. In the embodiment, a voltage level VCC/k1 (k1 is the aforementioned first amplification factor) is further provided and located between VSS and VCC, and a voltage level VCCN/k2 (k2 is the aforementioned second amplification factor) is further provided and located between VSS and VCCN. Accordingly, positive pixel data with MSBs=“00” are approximately located between VSS and VCC/k1, and positive pixel data with other MSBs (i.e., “01”, “10” and “11”) are approximately located between VCC/k1 and VDDAP. Also, negative pixel data with MSBs=“00” are approximately located between VSS and VCCN/k2, and negative pixel data with other MSBs (i.e., “01”, “10” and “11”) are approximately located between VCCN/k2 and VDDAN.

In the embodiment, if MSBs of a pixel datum corresponding to a required output voltage level to be outputted from a channel are “00”, indicating that the output voltage level is approximately within VSS and VCC/k1 for a polarity switching N→P, the 2-step pre-charging scheme discussed above is adopted without pre-charging to VCC; otherwise, if the MSBs are “01”, “10” or “11”, indicating that the output voltage level is approximately within VCC/k1 and VDDAP, the 3-step pre-charging scheme discussed above is adopted with pre-charging to VCC. Similarly, regarding the polarity switching P→N, if the MSBs are “00”, the 2-step pre-charging scheme discussed above is adopted without pre-charging to VCCN; otherwise, if the MSBs are “01” “10” or “11”, the 3-step pre-charging scheme discussed above is adopted with pre-charging to VCCN. Accordingly, pre-charging may be effectively performed based on the pixel datum corresponding to the required output voltage level to be outputted from the channel of the source driver. It is noted that, in practice, as VCC/k1 is not exactly separating pixel data with MSBs=“00” and pixel data with other MSBs, the embodiment discussed above may not be performed fully optimally but with some (tolerably) unfavorable area.

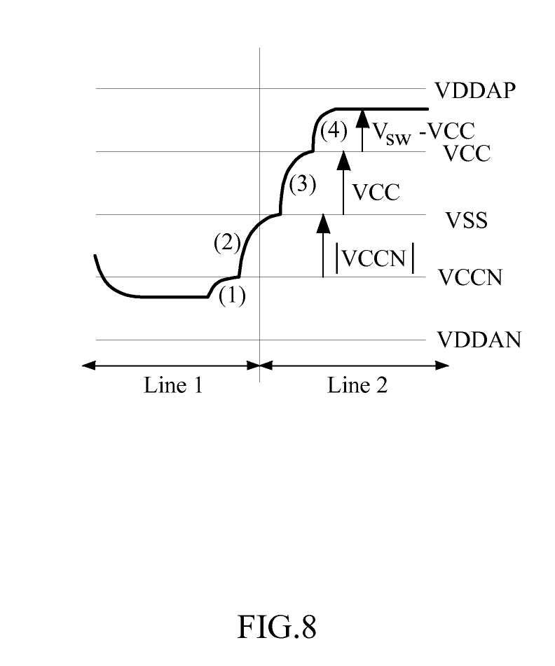

In addition to the 3-step pre-charging scheme illustrated in FIG. 4, a 4-step pre-charging scheme as shown in FIG. 8 may alternatively be adopted. Specifically, the 4-step pre-charging scheme (1) pre-charges an output voltage to VCCN, (2) subsequently pre-charges the output voltage from VCCN to VSS with a voltage swing equal to an absolute value of VCCN, (3) afterward pre-charges the output voltage from VSS to VCC with a voltage swing equal to VCC, and then (4) pulls the output voltage from VCC to a required output voltage level with a voltage swing designated as V_{SW}−VCC. The 4-step pre-charging scheme of FIG. 8 further conserve power because some charges may be discharged to VCCN in step (1). However, it is noted that the 4-step pre-charging scheme of FIG. 8 is not always consuming less power than the 3-step pre-charging scheme of FIG. 4. For example, if an original voltage level of line 2 of FIG. 8 is higher than VCCN (but less than VSS), more power will be consumed than the 3-step pre-charging scheme because the original voltage level is wastefully pulled down before it is pre-charged to VSS. The problem discussed above may be overcome by determining the MSB of a pixel datum corresponding to an original voltage level of a current line (e.g., line 2). If the MSB is “0”, indicating that the original voltage level of the current line is approximately within VCCN and VSS for a polarity switching the 3-step or 2-step pre-charging scheme discussed above is adopted without pre-charging to VCCN; otherwise, if the MSB is “1”, indicating that the original voltage level of the current line is approximately within VDDAN and VCCN, the 4-step pre-charging scheme discussed above is adopted with pre-charging to VCCN. Similarly, regarding the polarity switching P→N, if the MSB is “0”, the 2-step or 3-step pre-charging scheme discussed above is adopted without pre-charging to VCCN; otherwise, if the MSB is “1”, the 4-step pre-charging scheme discussed above is adopted with pre-charging to VCC.

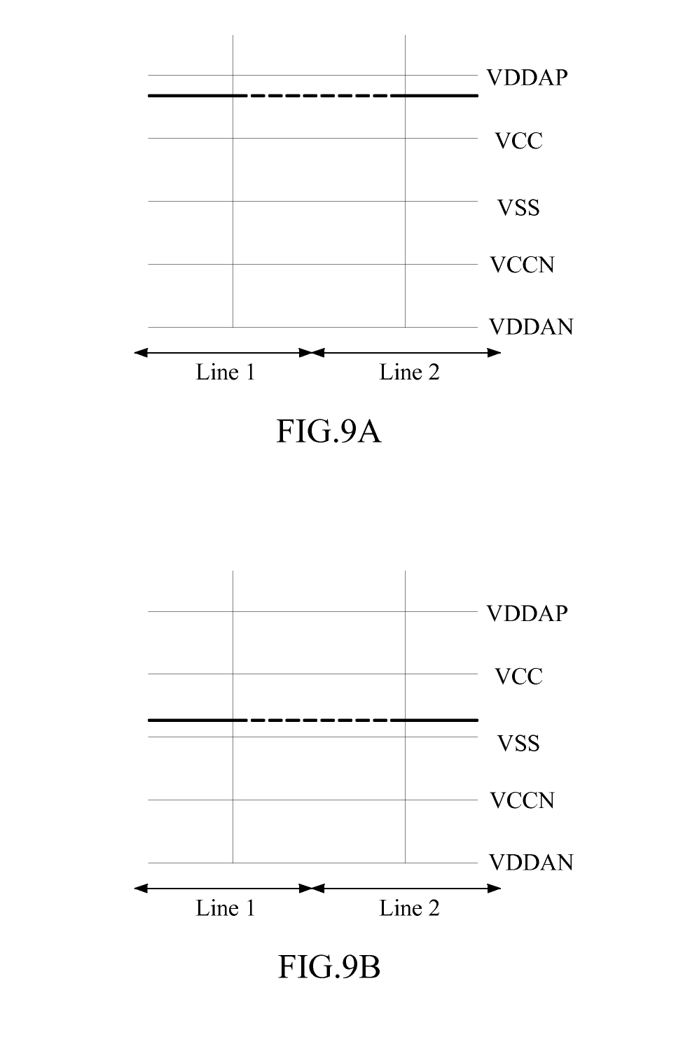

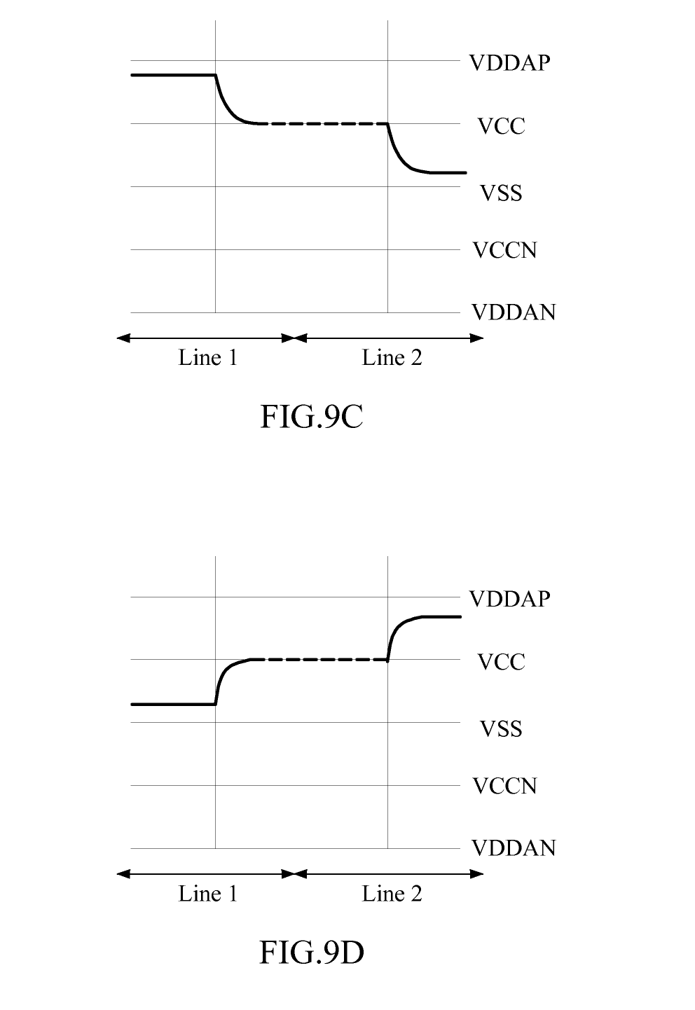

FIG. 9A through FIG. 9D show four cases of no polarity switching, where output voltage level difference between a current line (e.g., line 2) and a preceding line (e.g., line 1) is less than a predetermined threshold as exemplified in FIG. 9A/9B, and output voltage level difference between a current line and a preceding line is not less than the predetermined threshold as exemplified in FIG. 9C/9D. In the embodiment, when most channels of the source driver belong to the case of FIG. 9A/9B, no pre-charging is performed for all the channels. In the specification, the term “most” means majority of the channels, or a portion of the channels more than a predetermined amount. When most channels of the source driver belong to the case of FIG. 9C/9D, pre-charging to VCC for positive output voltage level (i.e., with polarity P) is performed for all the channels. Similarly, pre-charging to VCCN for negative output voltage level (i.e., with polarity N) is performed for all the channels.

Although specific embodiments have been illustrated and described, it will be appreciated by those skilled in the art that various modifications may be made without departing from the scope of the present invention, which is intended to be limited solely by the appended claims.

What is claimed is:

1. A method of data dependent pre-charging for a source driver of a liquid crystal display (LCD), comprising:
providing powers including a positive supply voltage (VCC) that is supplied from a power supply, a ground (VSS), a generated negative supply voltage (VCCN) that is generated by inverting VCC, a positive amplified supply voltage (VDDAP) that is generated based on VCC with a first amplification factor k1 and a negative amplified supply voltage (VDDAN) that is generated based on an inverted VCC with a second amplification factor k2, wherein a voltage located between VSS and VDDAP has a positive polarity (P), and a voltage located between VSS and VDDAN has a negative polarity (N); and
dynamically performing pre-charging among plural pre-charging schemes according to pixel data corresponding to required output voltage levels to be outputted from channels of the source driver, in case of polarity switching between a current line and a preceding line.

2. The method of claim 1, wherein the pre-charging schemes comprise:
a 2-step pre-charging scheme that pre-charges an output voltage to VSS, and then pulls the output voltage from VSS to a required output voltage level for switching from N to P; or pre-charges the output voltage to VSS, and then pulls the output voltage from VSS to the required output voltage level for switching from P to N; and
a 3-step pre-charging scheme that pre-charges the output voltage to VSS, subsequently pre-charges the output voltage from VSS to VCC, and then pulls the output voltage from VCC to the required output voltage level for switching from N to P; or pre-charges the output voltage to VSS, subsequently pre-charges the output voltage from VSS to VCCN, and then pulls the output voltage from VCCN to the required output voltage level for switching from P to N.

3. The method of claim 2, wherein the 2-step pre-charging scheme is adaptively performed, for switching from N to P, when the required output voltage level is located between VSS and VCC; otherwise, the 3-step pre-charging scheme is adaptively performed.

4. The method of claim 2, wherein the 2-step pre-charging scheme is adaptively performed, for switching from P to N, when the required output voltage level is located between VSS and VCCN; otherwise, the 3-step pre-charging scheme is adaptively performed.

5. The method of claim 2, wherein the 2-step pre-charging scheme is adaptively performed if a most-significant-bit (MSB) of a pixel datum corresponding to a required output voltage level to be outputted from a channel is “0”; otherwise, the 3-step pre-charging scheme is adaptively performed.

6. The method of claim 2, wherein the 2-step pre-charging scheme is adaptively performed if two most-significant-bits (MSBs) of a pixel datum corresponding to a required output voltage level to be outputted from a channel is “00”; otherwise, the 3-step pre-charging scheme is adaptively performed.

7. The method of claim 2, wherein the pre-charging schemes further comprise:
a 4-step pre-charging scheme that pre-charges the output voltage to VCCN, subsequently pre-charges the output voltage from VCCN to VSS, afterward pre-charges the output voltage from VSS to VCC, and then pulls the output voltage from VCC to the required output voltage level for switching from N to P; or pre-charges the output voltage to VCC, subsequently pre-charges the output voltage from VCC to VSS, afterward pre-charges the output voltage from VSS to VCCN, and then pulls the output voltage from VCCN to the required output voltage level for switching from P to N.

8. The method of claim 7, wherein the 4-step pre-charging scheme is adaptively performed, for switching from N to P, when an original voltage level is located between VDDAN and VCCN; otherwise, the 2-step or the 3-step pre-charging scheme is adaptively performed.

9. The method of claim 7, wherein the 4-step pre-charging scheme is adaptively performed, for switching from P to N, when an original voltage level is located between VCC and VDDAP; otherwise, the 2-step or the 3-step pre-charging scheme is adaptively performed.

10. The method of claim 7, wherein the 2-step or the 3-step pre-charging scheme is adaptively performed if a most-significant-bit (MSB) of a pixel datum corresponding to an original voltage level to be outputted from a channel is “0”; otherwise, the 4-step pre-charging scheme is adaptively performed.

11. The method of claim 1, wherein no pre-charging is performed for all the channel when output voltage level difference between a current line and a preceding line for most of the channels is less than a predetermined threshold, in case of no polarity switching between the current line and the preceding line.

12. The method of claim 11, wherein an output voltage of the source driver is pre-charged to VCC for P or pre-charged to VCCN for N for all the channels when output voltage level difference between the current line and the preceding line for most of the channels is not less than the predetermined threshold, in case of no polarity switching between the current line and the preceding line.
